(19) United States
(12) Patent Application Publication
(10) Pub. No.: US 2026/0285695 A1
(43) Pub. Date: Sep. 24, 2026

(54) METHOD FOR PRODUCING SILICA SOL AND SILICA SOL

(71) Applicant: FUJIMI INCORPORATED, Kiyosu-shi (JP)

(72) Inventors: Yusuke Kawasaki, Kiyosu-shi (JP); Masaaki Ito, Kiyosu-shi (JP); Shogo Tsubota, Kiyosu-shi (JP); Keiji Ashitaka, Kiyosu-shi (JP)

(73) Assignee: FUJIMI INCORPORATED, Kiyosu-shi (JP)

(21) Appl. No.: 19/567,725

(22) Filed: Mar. 16, 2026

(30) Foreign Application Priority Data
Mar. 19, 2025 (JP) 2025-045714

(51) Int. Cl. C01B 33/145; C01B 33/141; C09K 3/14

(52) U.S. Cl. CPC C01B 33/145; C01B 33/141; C09K 3/1409; C01P 2004/54; C01P 2004/62; C01P 2004/64; C01P 2006/40

(57) ABSTRACT

Disclosed herein is a method for producing a silica sol, including mixing continuously or intermittently a liquid (A) containing an alkaline catalyst, water, and a first organic solvent with a liquid (B) containing at least one of tetramethoxysilane or a condensate thereof, and a second organic solvent, wherein the mixing includes, after formation of silica particles in a mixed liquid, increasing a value of electrical conductivity of the mixed liquid.

### TECHNICAL FIELD

The present embodiment relates to a method for producing a silica sol and a silica sol.

### BACKGROUND ART

Chemical mechanical polishing (CMP) using polishing compositions has heretofore been performed on the surfaces of materials such as metals, semi-metals, non-metals, and oxides thereof. The polishing composition is generally formed by mixing/dispersing particles (abrasive grains) having the function of mechanical polishing into an aqueous solution having the function of chemical polishing, and a silica sol is known to be used as abrasive grains. In such a case, excellent polishing performance can be achieved by deforming silica particles.

Japanese Patent Laid-Open No. 2018-168031 (corresponding to U.S. Patent Application Publication No. 2020/0377371) discloses, as a method for deforming silica particles, a method for producing a silica sol, the method including the step of making a reaction liquid by mixing a liquid (A) containing an alkaline catalyst, water, a first organic solvent, and silica particles for association with a liquid (B) containing at least one of tetramethoxysilane or a condensate thereof, and a second organic solvent, wherein during the mixing, an addition rate of the liquid (B) is 8.5×10⁻⁴ to 5.6×10⁻³ mol/min in terms of silicon atoms with respect to 1 mol of water contained in the liquid (A).

### SUMMARY

The technique disclosed in Japanese Patent Laid-Open No. 2018-168031 (corresponding to U.S. Patent Application Publication No. 2020/0377371) makes it possible to obtain a silica sol containing highly associated silica particles and therefore to increase a polishing removal rate. However, for the purpose of, for example, reducing a haze value, it is required to increase the content of silica particles having a high aspect ratio in a silica sol.

In light of the above circumstances, it is therefore an object of the present embodiment to provide a method for producing a silica sol which is capable of increasing the content of silica particles having a high aspect ratio.

In order to achieve the above object, the present inventors have intensively studied and as a result have found that the above effect can be obtained by a method for producing a silica sol, the method including continuously or intermittently mixing a liquid (A) containing an alkaline catalyst, water, and a first organic solvent with a liquid (B) containing at least one of tetramethoxysilane or a condensate thereof, and a second organic solvent, wherein the mixing includes, after formation of silica particles in a mixed liquid, increasing a value of electrical conductivity of the mixed liquid. This finding has led to the completion of the present embodiment.

### BRIEF DESCRIPTION OF THE DRAWINGS

FIG. 1 is a diagram for illustrating a method for measuring the longest diameter of a silica primary particle.

### DESCRIPTION OF EMBODIMENTS

Hereinbelow, embodiments according to one aspect of the present embodiment will be described. The present embodiment is not limited only to the embodiments described below and can be variously modified within the scope of the present embodiment. Embodiments disclosed herein can be freely combined to provide other embodiments.

The phrase “X to Y” indicating a range herein means “X or more and Y or less”. Unless otherwise specified, operations and measurements of physical properties and the like are performed under conditions of room temperature (20 to 25° C.)/relative humidity 40 to 50% RH.

### <Method for Producing Silica Sol>

One aspect of the present embodiment relates to a method for producing a silica sol, the method including continuously or intermittently mixing a liquid (A) containing an alkaline catalyst, water, and a first organic solvent with a liquid (B) containing at least one of tetramethoxysilane or a condensate thereof, and a second organic solvent, wherein the mixing includes, after formation of silica particles in a mixed liquid, increasing a value of electrical conductivity of the mixed liquid. According to this aspect, a method for producing a silica sol is provided which is capable of increasing the content of silica particles having a high aspect ratio. Such a configuration provides a silica sol containing many silica particles having a high aspect ratio.

The silica sol containing silica particles having a high aspect ratio herein means that silica particles in the silica sol have an average aspect ratio of 1.5 or more. The silica particles in the silica sol according to this aspect preferably have an average aspect ratio of 1.5 or more and an average degree of circularity of 0.80 or less. The average aspect ratio and the average degree of circularity will be described later in <Silica sol>.

The silica sol containing many silica particles having a high aspect ratio herein means that the proportion of the number of silica particles having an aspect ratio of 1.50 or more to the total number of silica particles in the silica sol is 40% or more. The proportion of the number of silica particles having an aspect ratio of 1.50 or more to the total number of silica particles in the silica sol will be described later in <Silica sol>.

The phrase “at least one of tetramethoxysilane or a condensate thereof” is herein also collectively and simply referred to as “tetramethoxysilane and/or the like”.

The reason why the production method according to this aspect produces the effect described above is not necessarily clear but can be considered as follow.

In the production method according to this aspect, mixing the liquid (A) with the liquid (B) produces silica particles due to hydrolysis and polycondensation of the tetramethoxysilane and/or the like in the mixed liquid. It is considered that increasing the value of electrical conductivity of the mixed liquid after formation of silica particles allows the silica particles to easily bind together via hydrolyzed tetramethoxysilane and/or the like, thereby obtaining silica particles having a high aspect ratio.

The above mechanism is based on presumption, and correctness or incorrectness of the mechanism does not affect the technical scope of the present embodiment.

Hereinbelow, elements of the method for producing a silica sol according to this aspect will be described.

The method for producing a silica sol according to this aspect includes mixing continuously or intermittently a liquid (A) containing an alkaline catalyst, water, and a first organic solvent with a liquid (B) containing at least one of tetramethoxysilane or a condensate thereof, and a second organic solvent, wherein the mixing includes, after formation of silica particles in a mixed liquid, increasing a value of electrical conductivity of the mixed liquid.

The term “mixed liquid” herein includes a mixed liquid obtained by mixing the liquid (A) with the liquid (B) and a mixed liquid obtained by mixing the liquid (A) with the liquid (B) and a liquid (C) that will be described later.

The method for producing a silica sol according to this aspect includes mixing continuously or intermittently the liquid (A) with the liquid (B) (mixing step), and the mixing step includes, after formation of silica particles in a mixed liquid, that is, in the middle of the step, increasing a value of electrical conductivity of the mixed liquid. Specifically, the mixing step according to this aspect includes: mixing continuously or intermittently the liquid (A) with the liquid (B) to form silica particles in a mixed liquid (silica particle-forming step); increasing a value of electrical conductivity of the mixed liquid after the silica particle-forming step (electrical conductivity-increasing step); and mixing continuously or intermittently the mixed liquid after the electrical conductivity-increasing step with the liquid (B) to bind together and grow the silica particles in the mixed liquid (silica particle-growing step).

From the viewpoint that a high-purity silica sol can be easily produced (the purity of a silica sol can be increased), the method for producing a silica sol according to this aspect preferably uses a sol-gel method. In a preferred embodiment, the silica particle-forming step and the silica particle-growing step in the method for producing a silica sol according to this aspect use a sol-gel method.

### (Silica Particle-Forming Step)

In the silica particle-forming step, the liquid (A) containing an alkaline catalyst, water, and a first organic solvent is continuously or intermittently mixed with the liquid (B) containing at least one of tetramethoxysilane or a condensate thereof, and a second organic solvent to form silica particles in a mixed liquid.

The liquid (A) contains an alkaline catalyst, water, and a first organic solvent. The liquid (A) may contain another component in addition to the alkaline catalyst, the water, and the first organic solvent as long as the effect of the present embodiment is not impaired.

In a preferred embodiment, the liquid (A) consists of an alkaline catalyst, water, and a first organic solvent. When the liquid (A) consists of an alkaline catalyst, water, and a first organic solvent, impurities contained in the mixed liquid can be reduced as much as possible. This makes it possible to, when a silica sol obtained by the production method according to this aspect is used as a polishing slurry, reduce the influence of impurities on polishing. Further, the silica sol can be used also for objects to be polished, which are averse to metallic impurities, such as silicon wafers and device wafers, which makes it possible to provide a widely-applicable polishing slurry.

The alkaline catalyst contained in the liquid (A) may be conventionally-known one. From the viewpoint that contamination with metallic impurities or the like can be reduced as much as possible, examples of the alkaline catalyst include ammonia, ammonium salts such as tetramethylammonium hydroxide and the like, ethylenediamine, diethylenetriamine, triethylenetetramine, urea, monoethanolamine, diethanolamine, triethanolamine, and tetramethyl guanidine. Among them, from the viewpoint of excellent catalytic action, more preferred are ammonia and ammonium salts such as tetramethylammonium hydroxide and the like, and even more preferred is ammonia. Ammonia can be easily removed in the production process of a silica sol due to its high volatility. It should be noted that the alkaline catalyst to be used may be of one type or a mixture of two or more types. The alkaline catalyst may be in the form of an aqueous solution.

The water contained in the liquid (A) is preferably pure water or ultrapure water from the viewpoint of reducing contamination with metallic impurities or the like as much as possible. When the alkaline catalyst is in the form of an aqueous solution, water contained therein is regarded as the water contained in the liquid (A). Therefore, the water contained in the aqueous solution of the alkaline catalyst is also preferably pure water or ultrapure water.

The first organic solvent contained in the liquid (A) is preferably a hydrophilic organic solvent, and specific examples thereof include alcohols such as methanol ethanol, n-propanol, isopropanol, ethylene glycol, propylene glycol, and 1,4-butanediol; and ketones such as acetone and methyl ethyl ketone. The first organic solvent to be used may be of one type or a mixture of two or more types.

The first organic solvent is preferably the alcohols. The use of the alcohols has an effect that when a water substitution step that will be described later is performed, the alcohol can be easily substituted by water by heat distillation. Further, from the viewpoint of recovery and reuse of organic solvents, the first organic solvent is preferably methanol.

The contents of the alkaline catalyst, the water, and the first organic solvent in the liquid (A) are not limited and can be appropriately adjusted in such a manner that, for example, silica particles to be formed in a mixed liquid have a desired average secondary particle size.

From the viewpoint of the action of the alkaline catalyst as a hydrolysis catalyst and growth of silica particles, the lower limit of the content of the alkaline catalyst (e.g., ammonia) in the liquid (A) is, for example, 0.1% by mass or more, preferably 0.3% by mass or more relative to the total amount (100% by mass) of the liquid (A). The lower limit of the content of the alkaline catalyst (e.g., ammonia) may be 0.5% by mass or more, 1.0% by mass or more, or 2.0% by mass or more relative to the total amount (100% by mass) of the liquid (A). The upper limit of the content of the alkaline catalyst (e.g., ammonia) is not limited. From the viewpoint of productivity and cost, the upper limit of the content of the alkaline catalyst (e.g., ammonia) is preferably 50% by mass or less relative to the total amount (100% by mass) of the liquid (A). The upper limit of the content of the alkaline catalyst (e.g., ammonia) may be 40% by mass or less, 20% by mass or less, 15% by mass or less, 10% by mass or less, or 5% by mass or less relative to the total amount (100% by mass) of the liquid (A). The content of the alkaline catalyst (e.g., ammonia) may be 0.1% by mass or more and 50% by mass or less, 0.3% by mass or more and 40% by mass or less, 0.5% by mass or more and 20% by mass or less, 1.0% by mass or more and 15% by mass or less, 1.0% by mass or more and 10% by mass or less, 1.0% by mass or more and 5% by mass or less, 2.0% by mass or more and 15% by mass or less, 2.0% by mass or more and 10% by mass or less, or 2.0% by mass or more and 5% by mass or less relative to the total amount (100% by mass) of the liquid (A).

The content of the water in the liquid (A) is adjusted according to the amount of tetramethoxysilane or a condensate thereof used for reaction. From the viewpoint of hydrolysis of tetramethoxysilane, the lower limit of the content of the water is preferably 5% by mass or more relative to the total amount (100% by mass) of the liquid (A). From the viewpoint of compatibility with the liquid (B), the upper limit of the content of the water is preferably 50% by mass or less, more preferably 40% by mass or less relative to the total amount (100% by mass) of the liquid (A). The upper limit of the content of the water may be 20% by mass or less or 15% by mass or less relative to the total amount (100% by mass) of the liquid (A). The content of the water may be 5% by mass or more and 50% by mass or less, 5% by mass or more and 40% by mass or less, 5% by mass or more and 20% by mass or less, or 5% by mass or more and 15% by mass or less relative to the total amount (100% by mass) of the liquid (A).

From the viewpoint of compatibility with the liquid (B), the lower limit of the content of the first organic solvent (e.g., methanol) in the liquid (A) is preferably 10% by mass or more, more preferably 20% by mass or more relative to the total amount (100% by mass) of the liquid (A). The lower limit of the content of the first organic solvent (e.g., methanol) may be 50% by mass or more, 75% by mass or more, or 85% by mass or more relative to the total amount (100% by mass) of the liquid (A). From the viewpoint of dispersibility, the upper limit of the content of the first organic solvent (e.g., methanol) is preferably 98% by mass or less, more preferably 95% by mass or less relative to the total amount (100% by mass) of the liquid (A). The upper limit of the content of the first organic solvent (e.g., methanol) may be 94% by mass or less, 93% by mass or less, or 92% by mass or less. The content of the first organic solvent (e.g., methanol) may be 10% by mass or more and 98% by mass or less, 20% by mass or more and 95% by mass or less, 50% by mass or more and 95% by mass or less, 75% by mass or more and 95% by mass or less, or 85% by mass or more and 95% by mass or less relative to the total amount (100% by mass) of the liquid (A).

A method for producing the liquid (A) is not limited and may be, for example, a method in which an alkaline catalyst, water, a first organic solvent, and another optional component are mixed by stirring.

The liquid (B) contains at least one of tetramethoxysilane or a condensate thereof, and a second organic solvent. The liquid (B) may contain another component in addition to the at least one of tetramethoxysilane or a condensate thereof, and the second organic solvent as long as the effect of the present embodiment is not impaired.

In a preferred embodiment, the liquid (B) consists of at least one of tetramethoxysilane or a condensate thereof, and a second organic solvent. When the liquid (B) consists of at least one of tetramethoxysilane or a condensate thereof, and a second organic solvent, impurities contained in the mixed liquid can be reduced as much as possible. This makes it possible to, when a silica sol obtained by the production method according to this aspect is used as a polishing slurry, reduce the influence of impurities on polishing. Further, the silica sol can be used also for objects to be polished, which are averse to metallic impurities, such as silicon wafers and device wafers, which makes it possible to provide a widely-applicable polishing slurry.

The tetramethoxysilane or the condensate thereof contained in the liquid (B) may be of one type or a combination of two or more types. Among them, preferred is tetramethoxysilane from the view point that it has appropriate hydrolysis reactivity.

The second organic solvent contained in the liquid (B) is preferably a hydrophilic organic solvent, and specific examples thereof include alcohols such as methanol, ethanol, n-propanol, isopropanol, ethylene glycol, propylene glycol, and 1,4-butanediol; and ketones such as acetone and methyl ethyl ketone. The second organic solvent may be of one type or a mixture of two or more types.

The second organic solvent is preferably the alcohols. The use of the alcohols has an effect that, when a water substitution step that will be described later is performed, the alcohol can be easily substituted by water by heat distillation.

Among the alcohols, it is more preferably at least one selected from methanol, ethanol, isopropanol, and the like. From the viewpoint of recovery and reuse of organic solvents, it is even more preferably methanol generated by hydrolysis of tetramethoxysilane.

The contents of the tetramethoxysilane and/or the like and the second organic solvent in the liquid (B) are not limited and can be appropriately adjusted in such a manner that, for example, silica particles to be formed in a mixed liquid have a desired average secondary particle size.

The lower limit of the content of the tetramethoxysilane and/or the like in the liquid (B) is preferably 50% by mass or more, more preferably 60% by mass or more, even more preferably 70% by mass or more, particularly preferably 75% by mass or more. The upper limit of the content of the tetramethoxysilane and/or the like is preferably 98% by mass or less, more preferably 95% by mass or less, even more preferably 90% by mass or less, particularly preferably 85% by mass or less. The content of the tetramethoxysilane and/or the like is preferably 50% by mass or more and 98% by mass or less, more preferably 60% by mass or more and 95% by mass or less, even more preferably 70% by mass or more and 90% by mass or less, particularly preferably 75% by mass or more and 85% by mass or less.

The lower limit of the content of the second organic solvent (e.g., methanol) in the liquid (B) is preferably 2% by mass or more, more preferably 5% by mass or more, even more preferably 10% by mass or more, particularly preferably 15% by mass or more. The upper limit of the content of the second organic solvent (e.g., methanol) is preferably 50% by mass or less, more preferably 40% by mass or less, even more preferably 30% by mass or less, particularly preferably 25% by mass or less. The content of the second organic solvent (e.g., methanol) is preferably 2% by mass or more and 50% by mass or less, more preferably 5% by mass or more and 40% by mass or less, even more preferably 10% by mass or more and 30% by mass or less, particularly preferably 15% by mass or more and 25% by mass or less.

When the contents of the tetramethoxysilane and/or the like and the second organic solvent in the liquid (B) are within their respective ranges described above, miscibility with the liquid (A) during mixing can be improved.

The tetramethoxysilane condensate in the liquid (B) is, for example, a 2- to 12-mer, preferably a 4- to 8-mer.

A method for producing the liquid (B) is not limited. From the viewpoint of miscibility, the method for producing the liquid (B) is preferably a method in which the second organic solvent is mixed with the tetramethoxysilane and/or the like and another optional component by stirring.

The silica particle-forming step includes mixing continuously or intermittently the liquid (A) with the liquid (B). Mixing the liquid (A) with the liquid (B) produces silica particles due to hydrolysis and polycondensation of the tetramethoxysilane and/or the like in the mixed liquid.

The phrase “mixing continuously” means not to add the entire amount of a liquid at once during mixing but to add a liquid without interrupting during mixing.

The phrase “mixing intermittently” means not to add the entire amount of a liquid at once during mixing but to add a liquid in two or more separate portions during mixing.

In the silica particle-forming step, the liquid (A) and the mixed liquid are preferably stirred. A stirring speed is not limited and is, for example, 30 rpm or more and 500 rpm or less.

The addition rate of the liquid (B) in the silica particle-forming step is not limited and can be appropriately adjusted as long as a gel-like material is not produced. For example, the addition rate of the liquid (B) may be 8.5×10⁻⁴ mol/min or more and 5.6×10⁻³ mol/min or less in terms of silicon atoms per mole of water contained in the liquid (A). The phrase “in terms of silicon atoms” means that the mole number of silicon atoms contained in tetramethoxysilane and a condensate thereof is defined as the mole number of tetramethoxysilane and a condensate thereof. For example, 1 mol of tetramethoxysilane corresponds to 1 mol of silicon atoms. When the tetramethoxysilane condensate is a tetramer, 1 mol of the condensate corresponds to 4 mol of silicon atoms.

In the silica particle-forming step, the temperatures of the liquid (A), the liquid (B), and the mixed liquid of them are not limited and are, for example, 5° C. or more and 100° C. or less, preferably 5° C. or more and 70° C. or less. The temperatures of the liquid (A), the liquid (B), and the mixed liquid of them are preferably the same.

In the silica particle-forming step, a pressure condition during mixing is not limited and may be reduced pressure, ordinary pressure, or increased pressure. From the viewpoint of production cost, the pressure condition is preferably ordinary pressure.

In one embodiment, the mole ratio of the tetramethoxysilane and/or the like to the alkaline catalyst in the mixed liquid at the end of the silica particle-forming step is, for example, 0.10 or more and 0.80 or less, preferably 0.15 or more and 0.70 or less, more preferably 0.20 or more and 0.60 or less, even more preferably 0.25 or more and 0.55 or less. That is, in one embodiment, the silica particle-forming step includes mixing the liquid (A) with the liquid (B) in such a manner that the mole ratio of the tetramethoxysilane and/or the like to the alkaline catalyst contained in the liquid (A) falls within the above range. The mole ratio of the tetramethoxysilane and/or the like to the alkaline catalyst in the mixed liquid at the end of the silica particle-forming step is a value calculated from the amounts of the alkaline catalyst and the tetramethoxysilane and/or the like added.

In one embodiment, the silica particle-forming step may further include mixing at least one selected from the liquid (A) and the mixed liquid (which is obtained by mixing the liquid (A) with the liquid (B)) with a liquid (C) containing water. The liquid (C) may be continuously or intermittently mixed into the liquid (A) together with the liquid (B) or may be continuously or intermittently mixed into the mixed liquid obtained by mixing the liquid (A) with the liquid (B).

One embodiment of the method for producing a silica sol according to this aspect includes mixing continuously or intermittently a liquid (A) containing an alkaline catalyst, water, and a first organic solvent with a liquid (B) containing at least one of tetramethoxysilane or a condensate thereof, and a second organic solvent and a liquid (C) containing water, wherein the mixing includes, after formation of silica particles in a mixed liquid, increasing a value of electrical conductivity of the mixed liquid.

One embodiment of the method for producing a silica sol according to this aspect includes: mixing continuously or intermittently a liquid (A) containing an alkaline catalyst, water, and a first organic solvent with a liquid (B) containing at least one of tetramethoxysilane or a condensate thereof, and a second organic solvent and a liquid (C) containing water to form silica particles in a mixed liquid (silica particle-forming step); increasing a value of electrical conductivity of the mixed liquid after the silica particle-forming step (electrical conductivity-increasing step); and mixing continuously or intermittently the mixed liquid after the electrical conductivity-increasing step with the liquid (B) and the liquid (C) to bind together and grow the silica particles in the mixed liquid (silica particle-growing step).

The liquid (C) according to this embodiment includes water. The liquid (C) may contain another component as long as the effect of the present embodiment is not impaired.

In a preferred embodiment, the liquid (C) consists of water. When the liquid (C) consists of water, impurities contained in the mixed liquid can be reduced as much as possible. This makes it possible to, when a silica sol obtained by the production method according to this aspect is used as a polishing slurry, reduce the influence of impurities on polishing. Further, the silica sol can be used also for objects to be polished, which are averse to metallic impurities, such as silicon wafers and device wafers, which makes it possible to provide a widely-applicable polishing slurry.

From the viewpoint of reducing contamination with metallic impurities or the like as much as possible, the water contained in the liquid (C) is preferably pure water or ultrapure water.

The content of the water in the liquid (C) is preferably 95% by mass or more, more preferably 98% by mass or more, even more preferably 99% by mass or more, particularly preferably 100% by mass.

In one embodiment, the liquid (C) contains water and does not contain an alkaline catalyst.

A method for adding the liquid (B) and the liquid (C) at the time when at least one selected from the liquid (A) and the mixed liquid (which is obtained by mixing the liquid (A) with the liquid (B)) is mixed with the liquid (B) and the liquid (C) is not limited. Almost constant amounts of the liquid (B) and the liquid (C) may be added at the same time to at least one selected from the liquid (A) and the mixed liquid, or the liquid (B) and the liquid (C) may be alternately added to at least one selected from the liquid (A) and the mixed liquid. The liquid (B) and the liquid (C) may be added at random. Among them, from the viewpoint of reducing a change in the amount of water used for a synthesis reaction, preferred is a method in which the liquid (B) and the liquid (C) are added at the same time to at least one selected from the liquid (A) and the mixed liquid, and more preferred is a method in which constant amounts of the liquid (B) and the liquid (C) are added at the same time to at least one selected from the liquid (A) and the mixed liquid.

From the viewpoint that the concentration of the alkaline catalyst can be prevented from being locally increased, the method for adding the liquid (B) and the liquid (C) to at least one selected from the liquid (A) and the mixed liquid is preferably a method in which the liquid (B) and the liquid (C) are continuously mixed into at least one selected from the liquid (A) and the mixed liquid or a method in which the liquid (B) and the liquid (C) are intermittently mixed (e.g., dropped) into at least one selected from the liquid (A) and the mixed liquid.

The addition rates of the liquid (B) and the liquid (C) at the time when the liquid (B) and the liquid (C) are added and mixed into at least one selected from the liquid (A) and the mixed liquid are not limited and can be appropriately adjusted as long as a gel-like material is not produced. The addition rate of the liquid (B) may be the same as that described above. The addition rate of the liquid (C) is, for example, 1 mol/min or more and 3 mol/min or less, preferably 2 mol/min in terms of water per mole of tetramethoxysilane and a condensate thereof (in terms of silicon atoms) added as the liquid (B).

In the silica particle-forming step, the temperatures of the liquid (A), the liquid (B), the liquid (C), and the mixed liquid of them are not limited and are, for example, 5° C. or more and 100° C. or less, preferably 5° C. or more and 70° C. or less. The temperatures of the liquid (A), the liquid(B), the liquid (C), and the mixed liquid of them are preferably the same.

In such a manner as described above, a mixed liquid containing silica particles formed can be obtained. After confirming the formation of silica particles in the mixed liquid, the electrical conductivity-increasing step is allowed to proceed at any time point. The any time point may be a time point when addition of the entire amounts of the liquid (B) and the liquid (C), which is optionally added, to the liquid (A) has been completed or a time point when the average secondary particle size of the silica particles in the mixed liquid has reached a desired value. The formation of silica particles in the mixed liquid can be confirmed by a conventionally-known technique. The formation of silica particles in the mixed liquid can be confirmed by, for example, observation with a scanning electron microscope (SEM) or average secondary particle size measurement by a dynamic light scattering method typified by a laser diffraction/scattering method.

### (Electrical Conductivity-Increasing Step)

In the electrical conductivity-increasing step, the value of electrical conductivity of the mixed liquid obtained in the above-described silica particle-forming step is increased.

In one embodiment, the value of electrical conductivity of the mixed liquid is increased when the average secondary particle size of the silica particles is 5 nm or more and 300 nm or less, preferably 5 nm or more and 100 nm or less, more preferably 5 nm or more and 50 nm or less, even more preferably 10 nm or more and 30 nm or less. The average secondary particle size of the silica particles can be measured by, for example, a dynamic light scattering method typified by a laser diffraction/scattering method. More specifically, the average secondary particle size of the silica particles adopted herein is a value measured by a method that will be described later in Examples.

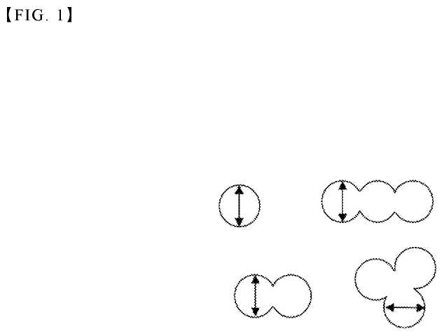

In one embodiment, the value of electrical conductivity of the mixed liquid is increased when the average of the longest diameters of silica primary particles is 2 nm or more and 50 nm or less, preferably 5 nm or more and 40 nm or less, more preferably 10 nm or more and 30 nm or less. The average of the longest diameters of silica primary particles means a value determined by measuring the longest diameters of silica primary particles as indicated by double-headed arrows in FIG. 1 and calculating an average of the longest diameters of all the silica primary particles subjected to measurement. The longest diameters of silica primary particles can be measured by, for example, observation with a scanning electron microscope (SEM). Specifically, the average of the longest diameters of silica primary particles adopted herein is a value measured by a method that will be described later in Examples.

In one embodiment, the mole ratio of the tetramethoxysilane and/or the like to the alkaline catalyst in the mixed liquid at the start of the electrical conductivity-increasing step is, for example, 0.10 or more and 0.80 or less, preferably 0.15 or more and 0.70 or less, more preferably 0.20 or more and 0.60 or less, even more preferably 0.25 or more and 0.55 or less. The mole ratio of the tetramethoxysilane and/or the like to the alkaline catalyst in the mixed liquid at the start of the electrical conductivity-increasing step is a value calculated from the amounts of the alkaline catalyst and the tetramethoxysilane and/or the like added in the silica particle-forming step.

The electrical conductivity-increasing step can be started at any time point after the formation of silica particles in the mixed liquid as described above and can be terminated (the subsequent silica particle-growing step is allowed to proceed) at a time point when the value of electrical conductivity of the mixed liquid after the silica particle-forming step has increased to a desired value (at a time point when the increase rate of the value of electrical conductivity of the mixed liquid has reached a desired value). The value of electrical conductivity of the mixed liquid can be measured by a method that will be described later in Examples.

In the electrical conductivity-increasing step, the increase rate of the value of electrical conductivity of the mixed liquid after the silica particle-forming step is preferably 110% or more from the viewpoint that the effect of the present embodiment can be enhanced. The upper limit of the increase rate is not limited and is, for example, 160% or less, preferably 140% or less. The increase rate (%) of the value of electrical conductivity is a value calculated by the following formula: electrical conductivity of mixed liquid at end of electrical conductivity-increasing step/electrical conductivity of mixed liquid at start of electrical conductivity-increasing step×100.

A method for increasing the value of electrical conductivity of the mixed liquid after the silica particle-forming step may be a method in which the amount of ions derived from the alkaline catalyst in the mixed liquid is increased. In one embodiment, the increasing the value of electrical conductivity of the mixed liquid after the silica particle-forming step is achieved by increasing the amount (concentration) of ions derived from the alkaline catalyst in the mixed liquid.

A method for increasing the amount of ions derived from the alkaline catalyst in the mixed liquid may be, for example, a method in which the temperature of the mixed liquid after the silica particle-forming step is decreased or a method in which a liquid (D) containing ammonia is added to the mixed liquid.

In a preferred embodiment, the increasing the value of electrical conductivity of the mixed liquid after the silica particle-forming step is achieved by decreasing the temperature of the mixed liquid.

The alkaline catalyst in the mixed liquid undergoes self-dissociation in water or allows water to dissociate to generate hydroxide ions. When the alkaline catalyst is, for example, ammonia (NH₃), ammonia in water results in such an equilibrium state as represented by the following formula.

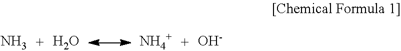

When the temperature of the mixed liquid is decreased, the alkaline catalyst (e.g., ammonia) in the mixed liquid undergoes self-dissociation in water or allows water to dissociate, which makes it possible to increase the amount of ions. The amount of ions in the mixed liquid is associated with the value of electrical conductivity of the mixed liquid, and therefore increasing the amount of ions in the mixed liquid can increase the value of electrical conductivity of the mixed liquid.

The “ions derived from the alkaline catalyst” herein include ions generated by self-dissociation of the alkaline catalyst in water and ions generated by dissociation of water caused by the alkaline catalyst.

In the case of decreasing the temperature of the mixed liquid, a value obtained by subtracting the temperature of the mixed liquid at the end of the electrical conductivity-increasing step from the temperature of the mixed liquid at the start of the electrical conductivity-increasing step is, for example, 5° C. or more, preferably 10° C. or more, more preferably 15° C. or more, even more preferably 20° C. or more.

In the case of decreasing the temperature of the mixed liquid, the temperature of the mixed liquid can be continuously or stepwise decreased, and is preferably continuously decreased.

A method for decreasing the temperature of the mixed liquid is not limited and may be, for example, a method in which a reaction container containing the mixed liquid is cooled to a desired temperature. In the case of cooling the mixed liquid, the mixed liquid may be stirred. A stirring speed is not limited and is, for example, 30 rpm or more and 500 rpm or less.

In the case of decreasing the temperature of the mixed liquid, the time required to decrease the temperature of the mixed liquid to a desired value is not limited and can be appropriately adjusted. The time required to decrease the temperature of the mixed liquid to a desired value may be, for example, 90 minutes or more.

In a preferred embodiment, the increasing the value of electrical conductivity of the mixed liquid after the silica particle-forming step is achieved by adding a liquid (D) containing ammonia to the mixed liquid. When the liquid (D) containing ammonia is added to the mixed liquid, the ammonia added to the mixed liquid undergoes self-dissociation in water or allows water to dissociate, which makes it possible to increase the amount of ions. This makes it possible to increase the value of electrical conductivity of the mixed liquid.

The liquid (D) preferably contains water in addition to ammonia. From the viewpoint of reducing contamination with metallic impurities or the like as much as possible, the water contained in the liquid (D) is preferably pure water or ultrapure water. The liquid (D) may contain another component in addition to ammonia and water as long as the effect of the present embodiment is not impaired. In one embodiment, the liquid (D) consists of ammonia and water.

The content of ammonia in the liquid (D) is not limited and is, for example, 1% by mass or more and 30% by mass or less relative to the total amount (100% by mass) of the liquid (D).

The content of water in the liquid (D) is not limited and is, for example, 70% by mass or more and 99% by mass or less relative to the total amount (100% by mass) of the liquid (D).

A method for adding the liquid (D) containing ammonia to the mixed liquid after the silica particle-forming step is not limited, and the liquid (D) may be added to the mixed liquid at once, or the liquid (D) may be continuously or intermittently added to the mixed liquid. Addition of the liquid (D) to the mixed liquid may be performed twice or more. In one embodiment, the increasing the value of electrical conductivity of the mixed liquid after the silica particle-forming step is achieved by adding the liquid (D) containing ammonia to the mixed liquid at once.

The amount of the liquid (D) containing ammonia to be added is not limited and can be set in such a manner that the increase rate of the value of electrical conductivity of the mixed liquid after the silica particle-forming step reaches a desired value.

The increasing the value of electrical conductivity of the mixed liquid after the silica particle-forming step may be achieved by a combination of decreasing the temperature of the mixed liquid after the silica particle-forming step and adding the liquid (D) containing ammonia to the mixed liquid after the silica particle-forming step.

In the electrical conductivity-increasing step, the mixed liquid may be mixed with only the liquid (B) or the liquid (C) or with both the liquid (B) and the liquid (C), or mixing of the mixed liquid with the liquid (B) and the liquid (C) may be stopped (interrupted). In the case of mixing the mixed liquid with the liquid (B), the amount of the liquid (B) to be added is preferably as small as possible, and in this case, the addition rate of the liquid (B) may be set to less than 8.5×10⁻⁴ mol/min in terms of silicon atoms per mole of water contained in the liquid (A). When containing ammonia, the liquid (C) may be used as the liquid (D). In the case of mixing the mixed liquid with the liquid (C) (excluding a case where the liquid (C) contains ammonia), the amount of the liquid (C) to be added is preferably as small as possible. In a preferred embodiment, from the viewpoint of increasing the amount (concentration) of ions derived from the alkaline catalyst in the mixed liquid, mixing of the mixed liquid with the liquid (B) or with the liquid (B) and the liquid (C) in the electrical conductivity-increasing step is stopped (interrupted).

In the case of mixing the mixed liquid with only the liquid (B) or the liquid (C) or with both the liquid (B) and the liquid (C) in the electrical conductivity-increasing step, the composition of the liquid (B) in the silica particle-forming step and the composition of the liquid (B) in the electrical conductivity-increasing step may be the same or different. The composition of the liquid (C) in the silica particle-forming step and the composition of the liquid (C) in the electrical conductivity-increasing step may be the same or different.

In such a manner as described above, a mixed liquid having an increased value of electrical conductivity can be obtained.

### (Silica Particle-Growing Step)

In the silica particle-growing step, the mixed liquid obtained in the electrical conductivity-increasing step is continuously or intermittently mixed with a liquid (B) containing at least one of tetramethoxysilane or a condensate thereof, and a second organic solvent to bind together and grow the silica particles in the mixed liquid. The mixed liquid obtained in the electrical conductivity-increasing step contains an increased amount of ions derived from the alkaline catalyst (e.g., ammonia) as compared to the mixed liquid obtained in the silica particle-forming step. Mixing the mixed liquid containing an increased amount of ions with the liquid (B) makes it easy to bind the silica particles together via hydrolyzed tetramethoxysilane and/or the like. This makes it possible to obtain a mixed liquid containing silica particles having a high aspect ratio.

The silica particle-growing step is started by adding the liquid (B) to the mixed liquid and is terminated by completing addition of the liquid (B). For example, the silica particle-growing step may be terminated by completing addition of the entire amount of the liquid (B) or by stopping addition of the liquid (B) at a time point when a mixed liquid containing silica particles having a desired average aspect ratio has been obtained. The silica particle-growing step may be performed in two or more stages.

Performing the silica particle-growing step makes it possible to increase the concentration (content) of silica particles in the mixed liquid. The lower limit of the concentration (content) of silica particles in the mixed liquid obtained in the silica particle-growing step is, for example, 4% by mass or more, preferably 5% by mass or more, more preferably 7% by mass or more, even more preferably 8% by mass or more, particularly preferably 9% by mass or more relative to the total mass of the mixed liquid. Performing the silica particle-growing step twice or more makes it possible to further increase the concentration (content) of silica particles in the mixed liquid. The upper limit of the concentration (content) of silica particles in the mixed liquid is not limited as long as gelation does not occur. The upper limit of the concentration (content) of silica particles in the mixed liquid may be 40% by mass or less, 35% by mass or less, 30% by mass or less, 25% by mass or less, or 20% by mass or less. The concentration (content) of silica particles in the mixed liquid may be 4% by mass or more and 40% by mass or less, 5% by mass or more and 35% by mass or less, 7% by mass or more and 30% by mass or less, 8% by mass or more and 25% by mass or less, or 9% by mass or more and 20% by mass or less.

In one embodiment, the silica particle-growing step may further include mixing the mixed liquid obtained in the electrical conductivity-increasing step with a liquid (C) containing water. That is, one embodiment of the method for producing a silica sol according to this aspect includes continuously or intermittently mixing a liquid (A) with a liquid (B) (mixing step), wherein the mixing (mixing step) includes, after formation of silica particles in a mixed liquid, increasing a value of electrical conductivity of the mixed liquid and further includes mixing at least one selected from the liquid (A) and the mixed liquid with a liquid (C) containing water.

The liquid (B) and the liquid (C) in the silica particle-growing step are as described above with reference to the silica particle-forming step. The composition of the liquid (B) in the silica particle-growing step and the composition of the liquid (B) in the silica particle-forming step may be the same or different. The composition of the liquid (C) in the silica particle-forming step and the composition of the liquid (C) in the silica particle-growing step may be the same or different.

In the silica particle-growing step, the mixed liquid is preferably stirred. A stirring speed is not limited and is, for example, 30 rpm or more and 500 rpm or less.

In the silica particle-growing step, the addition rate of the liquid (B) is not limited and can be appropriately adjusted as long as a gel-like material is not produced. For example, the addition rate of the liquid (B) can be set to 8.5×10⁻⁴ mol/min or more and 5.6×10⁻³ mol/min or less in terms of silicon atoms per mole of water contained in the liquid (A).

The addition rate of the liquid (B) may be the same as or different from the addition rate of the liquid (B) in the silica particle-forming step. From the viewpoint that the production time of a silica sol can be reduced, the addition rate of the liquid (B) may be twice or more the addition rate of the liquid (B) in the silica particle-forming step.

In the silica particle-growing step, the addition rates of the liquid (B) and the liquid (C) at the time when the liquid (B) and the liquid (C) are added and mixed into the mixed liquid are not limited and can be appropriately adjusted as long as a gel-like material is not produced. The addition rate of the liquid (B) may be the same as that described above. The addition rate of the liquid (C) is, for example, 1 mol/min or more and 3 mol/min or less, preferably 2 mol/min in terms of water per mole of tetramethoxysilane and a condensate thereof (in terms of silicon atoms) added as the liquid (B).

In the case of performing the silica particle-growing step twice or more, the compositions of the liquid (B) and the liquid (C) used, the addition rates of the liquid (B) and the liquid (C), and the temperatures of the liquid (B), the liquid (C), and the mixed liquid may be the same or different between the respective steps.

In such a manner as described above, a mixed liquid can be obtained which contains a larger amount of silica particles having a high aspect ratio.

In the production method according to this aspect, the mixed liquid obtained in the silica particle-growing step can be directly used as a silica sol. The mixed liquid obtained in the silica particle-growing step may be subjected to a post-processing step or the like that will be described later. In a preferred embodiment, from the viewpoint that aggregation of silica particles can be prevented, a water substitution step is performed in which an organic solvent present in the mixed liquid obtained in the silica particle-growing step is substituted by water.

### (Post-Processing Step)

In the method for producing a silica sol according to this aspect, a post-processing step that will be described below may be performed after the silica particle-growing step is performed.

Specifically, at least one selected from a water substitution step in which an organic solvent present in the mixed liquid obtained in the silica particle-growing step is substituted by water and a concentration step in which the mixed liquid obtained in the silica particle-growing step is concentrated may be performed. More specifically, only a concentration step may be performed in which the mixed liquid obtained in the silica particle-growing step is concentrated, only a water substitution step may be performed in which an organic solvent in the mixed liquid obtained in the silica particle-growing step is substituted by water, a water substitution step may be performed in which an organic solvent in a mixed liquid after the concentration step is substituted by water, or a concentration step may be performed in which a mixed liquid after the water substitution step is concentrated. Multiple concentration steps may be performed, and in this case, a water substitution step may be performed between a concentration step and another concentration step. For example, when, after a concentration step, a water substitution step is performed in which an organic solvent in a concentrated liquid is substituted by water, another concentration step may be performed in which the liquid subjected to water displacement is concentrated.

### (Water Substitution Step)

One embodiment of the method for producing a silica sol according to this aspect may include a step in which an organic solvent contained in the mixed liquid obtained in the silica particle-growing step is substituted by water (herein also simply referred to as a “water substitution step”). The mixed liquid used in this embodiment also includes one obtained by concentrating the mixed liquid obtained in the silica particle-growing step.

Substituting an organic solvent in the mixed liquid obtained in the silica particle-growing step by water makes it possible to, when ammonia is selected as an alkaline catalyst, adjust the pH of the produced silica sol to a neutral range and to remove unreacted materials contained in the mixed liquid obtained in the silica particle-growing step, thereby obtaining a silica sol stable for a long period of time.

A method for substituting an organic solvent in the mixed liquid obtained in the silica particle-growing step by water may be a conventionally-known method, and an example thereof is a method in which an organic solvent is substituted by heat distillation while water is dropped in such a manner that the amount of the mixed liquid obtained in the silica particle-growing step is maintained at a certain level or more. In this case, the operation of substitution is preferably performed until a liquid temperature and a tower top temperature reach the boiling point of water for substitution.

From the viewpoint of reducing contamination with metallic impurities or the like as much as possible, the water used in this step is preferably pure water or ultrapure water.

Another example of the method for substituting an organic solvent in the mixed liquid obtained in the silica particle-growing step by water is a method in which the mixed liquid obtained in the silica particle-growing step is centrifuged to separate silica particles and then the silica particles are redispersed in water.

### (Concentration Step)

One embodiment of the method for producing a silica sol according to this aspect may include a step in which the mixed liquid obtained in the silica particle-growing step is further concentrated (herein also simply referred to as a “concentration step”). It should be noted that the mixed liquid used in this embodiment also includes one obtained by subjecting the mixed liquid obtained in the silica particle-growing step to water substitution.

A method for concentrating the mixed liquid obtained in the silica particle-growing step is not limited and may be a conventionally-known method, and examples thereof include a heating concentration method and a membrane concentration method.

In the case of a heating concentration method, the mixed liquid obtained in the silica particle-growing step can be subjected to heating concentration under ordinary pressure or reduced pressure to obtain a concentrated mixed liquid.

In the case of a membrane concentration method, the silica sol obtained in the silica particle-growing step can be concentrated by membrane separation based on ultrafiltration capable of filtering silica particles. The molecular weight cut-off of an ultrafiltration membrane is not limited and can be selected according to the particle size of particles produced. A material constituting the ultrafiltration membrane is not limited and examples thereof include polysulfone, polyacrylonitrile, a sintered metal, ceramic, and carbon. The form of ultrafiltration membrane may be of any type such as spiral, tubular, or hollow fiber. The operating pressure of ultrafiltration is not limited and can be set to be equal to or lower than the working pressure of an ultrafiltration membrane to be used.

The physical properties of silica particles in the silica sol produced by the method for producing a silica sol according to this aspect will be described later in <Silica sol> that is another aspect of the present embodiment.

### <Silica Sol>

Another aspect of the present embodiment relates to a silica sol containing silica particles having an average aspect ratio of 1.50 or more, wherein a proportion of the number of silica particles having an aspect ratio of 1.50 or more to the total number of silica particles is 40% or more, and a concentration of the silica particles is 4% by mass or more. The silica particles contained in the silica sol according to this aspect have a high average aspect ratio, which makes it possible to improve polishing performance and reduce, for example, a haze.

The silica sol according to this aspect can be obtained by the above-described method for producing a silica sol. From the viewpoint of obtaining a higher-purity silica sol, the silica sol according to this aspect is preferably a silica sol produced using a sol-gel method. In a preferred embodiment, the silica sol according to this aspect is a silica sol obtained by the above-described method for producing a silica sol using a sol-gel method.

The aspect ratio herein means a value determined by measuring the long and short sides of a minimum rectangle circumscribing a silica particle and calculating the ratio of the long side to the short side (long side/short side). The average aspect ratio refers to a calculated average of the aspect ratios of a predetermined number (e.g., 100 or more) of silica particles. The aspect ratio and the average aspect ratio can be understood by, for example, observation with a scanning electron microscope (SEM). More specifically, the aspect ratio and the average aspect ratio adopted herein are values measured by a method that will be described in Examples.

The proportion of the number of silica particles having an aspect ratio of 1.50 or more to the total number of silica particles can be determined by determining the aspect ratios of all silica particles (e.g., 100 or more silica particles) in an SEM image obtained by observation with a scanning electron microscope (SEM) and calculating the proportion (%) of the number of silica particles having an aspect ratio of 1.50 or more in the SEM image to the total number of silica particles in the SEM image (=number of silica particles having aspect ratio of 1.50 or more in SEM image/total number of silica particles in SEM image×100). The details of the measurement method will be described in Examples.

The lower limit of the average aspect ratio of silica particles in the silica sol according to this aspect is 1.50 or more. The upper limit of the average aspect ratio of the silica particles is, for example, 5.00 or less, preferably 4.00 or less, more preferably 3.00 or less. The upper limit of the average aspect ratio of the silica particles may be 2.00 or less, 1.80 or less, or 1.65 or less. The average aspect ratio of the silica particles is preferably 1.50 or more and 5.00 or less, more preferably 1.50 or more and 4.00 or less, even more preferably 1.50 or more and 3.00 or less. The average aspect ratio of the silica particles may be 1.50 or more and 2.00 or less, 1.50 or more and 1.80 or less, or 1.50 or more and 1.65 or less.

The lower limit of the proportion of the number of silica particles having an aspect ratio of 1.50 or more to the total number of silica particles in the silica sol according to this aspect is 40% or more, preferably 50% or more. The upper limit of the proportion of the number of silica particles having an aspect ratio of 1.50 or more to the total number of silica particles is not limited and may be, for example, 80% or less, 70% or less, or 60% or less. The proportion of the number of silica particles having an aspect ratio of 1.50 or more to the total number of silica particles is, for example, 40% or more and 80% or less. The proportion of the number of silica particles having an aspect ratio of 1.50 or more to the total number of silica particles may be 50% or more and 70% or less or 50% or more and 60% or less.

The proportion of the number of silica particles having a degree of circularity of 0.90 or more to the total number of silica particles in the silica sol according to this aspect is preferably 40% or less.

A preferred embodiment of the present embodiment relates to a silica sol containing silica particles having an average aspect ratio of 1.50 or more, wherein a proportion of the number of silica particles having an aspect ratio of 1.50 or more to the total number of silica particles is 40% or more, a proportion of the number of silica particles having a degree of circularity of 0.90 or more to the total number of silica particles is 40% or less, and a concentration of the silica particles is 4% by mass or more.

The proportion of the number of silica particles having a degree of circularity of 0.90 or more to the total number of silica particles can be determined by measuring the degree of circularity of each silica particle in an SEM image obtained by observation with a scanning electron microscope (SEM) and calculating the ratio (%) of the number of silica particles having a degree of circularity of 0.90 or more in the SEM image to the total number of silica particles (e.g., 100 or more) in the SEM image (=number of silica particles having degree of circularity of 0.90 or more in SEM image/total number of silica particles in SEM image×100). The details of the measurement method will be described in Examples.

The upper limit of the proportion of the number of silica particles having a degree of circularity of 0.90 or more to the total number of silica particles in the silica sol according to this aspect is more preferably 30% or less. The lower limit of the proportion of the number of silica particles having a degree of circularity of 0.90 or more to the total number of silica particles is not limited and may be, for example, 5% or more or 10% or more. The proportion of the number of silica particles having a degree of circularity of 0.90 or more to the total number of silica particles is preferably 5% or more and 40% or less, more preferably 10% or more and 30% or less.

The average degree of circularity of silica particles in the silica sol according to this aspect is preferably 0.80 or less. A preferred embodiment of the present embodiment relates to a silica sol containing silica particles having an average aspect ratio of 1.50 or more, wherein a proportion of the number of silica particles having an aspect ratio of 1.50 or more to the total number of silica particles is 40% or more, and a proportion of the number of silica particles having a degree of circularity of 0.90 or more to the total number of silica particles is 40% or less, an average degree of circularity of the silica particles is 0.80 or less, and a concentration of the silica particles is 4% by mass or more.

The average degree of circularity herein means a calculated average of degrees of circularity of all silica particles contained in a silica sol. The average degree of circularity adopted herein is a value measured by a method that will be described in Examples.

The upper limit of the average degree of circularity of the silica particles is more preferably 0.75 or less. The lower limit of the average degree of circularity of the silica particles is not limited and may be, for example, 0.30 or more, 0.40 or more, or 0.50 or more. The average degree of circularity of the silica particles is preferably 0.30 or more and 0.80 or less, more preferably 0.40 or more and 0.75 or less, even more preferably 0.50 or more and 0.75 or less.

The lower limit of the average primary particle size of silica particles in the silica sol according to this aspect is not limited and is, for example, 5 nm or more, preferably 10 nm or more, more preferably 20 nm or more. The upper limit of the average primary particle size of the silica particles is not limited and is, for example, 150 nm or less, preferably 100 nm or less, more preferably 50 nm or less. The average primary particle size of the silica particles may be 5 nm or more and 150 nm or less, 10 nm or more and 100 nm or less, or 20 nm or more and 50 nm or less. The average primary particle size of the silica particles can be calculated on the basis of the specific surface area (SA) of the silica particles calculated by a BET method and the density of the silica particles. More specifically, the average primary particle size of the silica particles adopted herein is a value measured by a method that will be described in Examples.

The average secondary particle size of silica particles in the silica sol according to this aspect is, for example, 5 nm or more and 300 nm or less, preferably 20 nm or more and 150 nm or less. The average secondary particle size of the silica particles can be measured by, for example, a dynamic light scattering method typified by a laser diffraction/scattering method. More specifically, the average secondary particle size of the silica particles adopted herein is a value measured by a method that will be described in Examples.

The average degree of association (the ratio of average secondary particle size to average primary particle size) of silica particles in the silica sol according to this aspect is, for example, 1.0 or more, preferably 1.0 or more and 10 or less, more preferably 1.3 or more and 7.0 or less, even more preferably 1.5 or more and 5.0 or less.

The concentration (content) of silica particles in the silica sol according to this aspect is 4% by mass or more relative to the total mass of the silica sol. The lower limit of the concentration (content) of the silica particles is preferably 5% by mass or more, more preferably 7% by mass or more, even more preferably 8% by mass or more, particularly preferably 9% by mass or more relative to the total mass of the silica sol. The silica sol according to this aspect produced by the above-described method for producing a silica sol can contain 4% by mass or more of silica particles without being subjected to the above-described concentration step. The upper limit of the concentration (content) of the silica particles is not limited as long as gelation does not occur. The upper limit of the concentration (content) of silica particles in the silica sol may be 40% by mass or less, 35% by mass or less, 30% by mass or less, 25% by mass or less, or 20% by mass or less. The concentration (content) of the silica particles may be 4% by mass or more and 40% by mass or less, 5% by mass or more and 35% by mass or less, 7% by mass or more and 30% by mass or less, 8% by mass or more and 25% by mass or less, or 9% by mass or more and 20% by mass or less.

The pH of the silica sol according to this aspect is not limited as long as gelation does not occur. For example, the pH of a silica sol obtained by the above-described production method may be 5.0 or more and 8.0 or less or 6.5 or more and 7.5 or less. The pH of the silica sol can be measured by a pH meter.

The silica sol according to this aspect may contain water. The concentration (content) of water in the silica sol is not limited and can be appropriately adjusted according to the concentration (content) of silica particles.

The silica sol may contain, as components other than water, components derived from the above-described production process. Examples of the components other than water include an alkaline catalyst, an organic solvent, tetramethoxysilane and a condensate thereof, and metallic impurities. Such components other than silica particles and water are preferably removed as much as possible. The content of the components other than silica particles and water in the silica sol is preferably 0.0001% by mass or less, more preferably 0% by mass. As described above, from the viewpoint of achieving higher purity, the silica sol according to this aspect is preferably a silica sol produced using a sol-gel method.

### <Intended Use>

The silica sol according to this aspect can be used for various purposes. Particularly, the silica sol according to this aspect can be appropriately used as abrasive grains for polishing an object to be polished such as a semiconductor substrate. Examples of the object to be polished include: metals or semi-metals such as silicon materials, aluminum, nickel, tungsten, steel, tantalum, titanium, and stainless steel and alloys thereof, glassy materials such as quartz glass, aluminosilicate glass, and glassy carbon; ceramic materials such as alumina, silica, sapphire, silicon nitride, tantalum nitride, and titanium carbide; compound semiconductor substrate materials such as silicon carbide, gallium nitride, and gallium arsenide; and resin materials such as polyimide resins. Further, a silica sol produced by the production method according to the present embodiment can be used for fillers for resin (e.g., fillers for sealing semiconductor devices), hard coating agents, resin modifiers, surface treatment agents, coating materials, pigments, catalysts, anti-slipping agents, spacers for liquid crystal displays, fiber treating agents, binders, adhesives, polymer flocculants, toners, detergents, cosmetics, dental materials, nanocomposites, heat-sensitive recording media, photosensitive films, and clarifying agents.

The present embodiment includes the following aspects and embodiments.
[1] A method for producing a silica sol, including:
mixing continuously or intermittently a liquid (A) containing an alkaline catalyst, water, and a first organic solvent with a liquid (B) containing at least one of tetramethoxysilane or a condensate thereof, and a second organic solvent, wherein
the mixing includes, after formation of silica particles in a mixed liquid, increasing a value of electrical conductivity of the mixed liquid.
[2] The production method according to [1], wherein the increasing a value of electrical conductivity of the mixed liquid is achieved by increasing an amount of ions derived from the alkaline catalyst in the mixed liquid.
[3] The production method according to [1] or [2], wherein the increasing a value of electrical conductivity of the mixed liquid is achieved by decreasing a temperature of the mixed liquid.
[4] The production method according to any one of [1] to [3], wherein the increasing a value of electrical conductivity of the mixed liquid is achieved by adding a liquid (D) containing ammonia to the mixed liquid.
[5] The production method according to any one of [1] to [4], wherein the mixing further includes mixing at least one selected from the liquid (A) and the mixed liquid with a liquid (C) containing water.
[6] The production method according to any one of [1] to [5], wherein an increase rate of the value of electrical conductivity of the mixed liquid is 110% or more.
[7] The production method according to any one of [1] to [6], wherein the value of electrical conductivity of the mixed liquid is increased when the silica particles have an average secondary particle size of 5 nm or more and 300 nm or less.
[8] A silica sol containing silica particles having an average aspect ratio of 1.50 or more, wherein
a proportion of the number of silica particles having an aspect ratio of 1.50 or more to the total number of silica particles is 40% or more, and
a concentration of the silica particles is 4% by mass or more.
[9] The silica sol according to [8], wherein a proportion of the number of silica particles having a degree of circularity of 0.90 or more to the total number of silica particles is 40% or less.

### EXAMPLES

The present embodiment will be described in more detail with reference to the following Examples and Comparative Examples. However, the technical scope of the present embodiment is not limited only to the following Examples. It should be noted that unless otherwise specified, “%” and “part(s)” mean “% by mass” and “part(s) by mass”, respectively. In the following Examples, operations were performed under conditions of room temperature (20 to 25° C.)/relative humidity 40 to 50% RH unless otherwise specified.

### <Measurement Methods of Various Physical Properties>

In Examples and Comparative Examples, various physical properties were measured by the following methods.

### (Scanning Electron Microscope (SEM) Image)

Silica particles in a mixed liquid and a silica sol were observed with a scanning electron microscope (SEM), SU8000 (manufactured by Hitachi High-Technologies Corporation) to take SEM images at a magnification such that 100 or more and 1000 or less particles were imaged.

### (Average of Longest Diameters of Silica Primary Particles)

For all silica particles in the SEM image taken for the mixed liquid, the longest diameter of each silica primary particle was measured as indicated by a double-headed arrow in FIG. 1, and an average of the longest diameters of silica primary particles was calculated.

### (Average Primary Particle Size)

The average primary particle size of silica particles in the silica sol was calculated by a formula of primary particle size=6000/(SA×2.2) wherein SA is a specific surface area of silica particles measured by a BET method using a full-automatic specific surface area analyzer, Macsorb (registered trademark) HM Model-1201 (manufactured by Mountech Co., Ltd.) and 2.2 is a true specific gravity (g/cm³) of silica.

### (Average Secondary Particle Size)

The average secondary particle sizes of silica particles in the mixed liquid and the silica sol were measured as volume-average particle sizes by a dynamic light scattering method using a particle size distribution analyzer (UPA-UT151 manufactured by NIKKISO CO., LTD.).

### (Electrical Conductivity)

The electrical conductivity of the mixed liquid was measured by immersing an electrode of a portable electrical conductivity meter, D-210C (manufactured by HORIBA, Ltd.) in the mixed liquid.

### (Average of Aspect Ratios)

For silica particles in the silica sol, the long and short sides of a minimum rectangle circumscribing each silica particle in the taken SEM image were measured, and the ratio of the long side to the short side (long side/short side) was calculated as an aspect ratio. The average of aspect ratios of all silica particles in the taken SEM image was calculated.

### (Proportion of Number of Silica Particles Having Aspect Ratio of 1.50 or More to Total Number of Silica Particles)

For silica particles in the silica sol, the long and short sides of a minimum rectangle circumscribing each silica particle in the taken SEM image were measured, and the ratio of the long side to the short side (long side/short side) was calculated as an aspect ratio. The proportion (%) of the number of silica particles having an aspect ratio of 1.50 or more in the SEM image to the total number of silica particles in the SEM image (=number of silica particles having aspect ratio of 1.50 or more in SEM image/total number of silica particles in SEM image×100) was calculated.

### (Average Degree of Circularity)

For silica particles in the silica sol, the degree of circularity of each silica particle in the taken SEM image was measured, and the average of degrees of circularity of all silica particles in the taken SEM image was calculated. The degree of circularity was calculated from the area (S) and perimeter (L) of a silica particle using the following formula:

Degree of circularity=4πS/L² (S=area of circle, L=perimeter)

### (Proportion of Number of Silica Particles Having Degree of Circularity of 0.90 or More to Total Number of Silica Particles)

For silica particles in the silica sol, the degree of circularity of each silica particle in the taken SEM image was measured. The proportion (%) of the number of silica particles having a degree of circularity of 0.90 or more in the SEM image to the total number of silica particles in the SEM image (=number of silica particles having degree of circularity of 0.90 or more in SEM image/total number of silica particles in SEM image×100) was calculated.

### Example 1

### (Silica Particle-Forming Step)

A liquid (A) obtained by mixing 1296 g of methanol (manufactured by KANTO CHEMICAL CO., INC.) with 65 g of pure water and 116 g of 29 mass % ammonia water was placed in a 3-liter reaction container having a cooling function and equipped with a stirrer. A liquid (B) obtained by dissolving 88 g of tetramethoxysilane (TMOS manufactured by TAMA CHEMICALS CO., LTD.) in 22 g of methanol and a liquid (C) consisting of 21 g of pure water were continuously added and mixed into the liquid (A) at the same time with stirring at 300 rpm while the liquid temperature (mixed liquid temperature) in the reaction container was maintained at 50° C. to prepare a mixed liquid to allow a synthesis reaction to proceed.

The addition rate of the liquid (B) was 1.4×10⁻³ mol/min in terms of silicon atoms per mole of water contained in the liquid (A). The liquid (C) was added at 2 mol/min per mole of tetramethoxysilane added as the liquid (B).

The progress of the synthesis reaction was terminated by completing addition of the entire amounts of the liquid (B) and the liquid (C) to obtain a mixed liquid containing silica particles formed. Formation of silica particles in the mixed liquid was confirmed by measuring the average of the longest diameters of silica primary particles, the average secondary particle size of the silica particles, and the concentration of the silica particles in the mixed liquid. The average of the longest diameters of silica primary particles formed was 21 nm. The average secondary particle size of the silica particles formed was 22 nm. The concentration of the silica particles in the mixed liquid was 2.2% by mass.

### (Electrical Conductivity-Increasing Step)

The electrical conductivity of the mixed liquid obtained in the silica particle-forming step (the electrical conductivity of the mixed liquid at the start of the electrical conductivity-increasing step) was measured. After the measurement, the mixed liquid was cooled to 30° C. in 90 minutes while being stirred at 300 rpm to obtain a mixed liquid having an increased electrical conductivity. At the time when the temperature of the mixed liquid had decreased to 30° C., the electrical conductivity of the mixed liquid (the electrical conductivity of the mixed liquid at the end of the electrical conductivity-increasing step) was measured. The electrical conductivity of the mixed liquid at the end of the electrical conductivity-increasing step increased to 128% (=electrical conductivity of mixed liquid at end of electrical conductivity-increasing step/electrical conductivity of mixed liquid at start of electrical conductivity-increasing step×100) as compared to that at the start of cooling.

### (Silica Particle-Growing Step 1)

A liquid (B) obtained by dissolving 88 g of tetramethoxysilane (TMOS manufactured by TAMA CHEMICALS CO., LTD.) in 22 g of methanol and a liquid (C) consisting of 21 g of pure water were continuously added at the same time to the mixed liquid obtained in the electrical conductivity-increasing step with stirring at 300 rpm while the liquid temperature (mixed liquid temperature) in the reaction container was maintained at 30° C. to allow the reaction to proceed.

The addition rate of the liquid (B) was set to 2.8×10⁻³ mol/min in terms of silicon atoms per mole of water contained in the liquid (A). The liquid (C) was added at 2 mol/min per mole of tetramethoxysilane added as the liquid (B).

The progress of the reaction was terminated by completing addition of the entire amounts of the liquid (B) and the liquid (C) to obtain a mixed liquid containing grown silica particles. The concentration of the silica particles in the mixed liquid was 4.0% by mass.

### (Silica Particle-Growing Step 2)

A liquid (B) obtained by dissolving 379 g of tetramethoxysilane (TMOS manufactured by TAMA CHEMICALS CO., LTD.) in 95 g of methanol and a liquid (C) consisting of 90 g of pure water were continuously added at the same time to the mixed liquid obtained in the silica particle-growing step 1 with stirring at 300 rpm while the liquid temperature (mixed liquid temperature) in the reaction container was maintained at 30° C. to allow the reaction to proceed.

The addition rate of the liquid (B) was set to 3.5×103 mol/min in terms of silicon atoms per mole of water contained in the liquid (A). The liquid (C) was added at 2 mol/min per mole of tetramethoxysilane added as the liquid (B).

The progress of the reaction was terminated by completing addition of the entire amounts of the liquid (B) and the liquid (C) to obtain a mixed liquid containing grown silica particles. The concentration of the silica particles in the mixed liquid was 9.5% by mass.

### (Water Substitution Step)

The mixed liquid obtained in the silica particle-growing step 2 was heated at a temperature such that a boiling state was reached under ordinary pressure. During the heating, heat distillation was performed while pure water was added in such a manner that the liquid surface was kept at a certain level to displace methanol in the mixed liquid by pure water, thereby obtaining a silica sol.

### Example 2

### (Silica Particle-Forming Step)

A liquid (A) obtained by mixing 1341 g of methanol (manufactured by KANTO CHEMICAL CO., INC.) with 21 g of pure water and 116 g of 29 mass % ammonia water was placed in a 3-liter reaction container having a cooling function and equipped with a stirrer. A liquid (B) obtained by dissolving 88 g of tetramethoxysilane (TMOS manufactured by TAMA CHEMICALS CO., LTD.) in 22 g of methanol and a liquid (C) consisting of 21 g of pure water were continuously added and mixed into the liquid (A) at the same time with stirring at 300 rpm while the liquid temperature (mixed liquid temperature) in the reaction container was maintained at 50° C. to prepare a mixed liquid to allow a synthesis reaction to proceed.

The addition rate of the liquid (B) was 2.0×10⁻³ mol/min in terms of silicon atoms per mole of water contained in the liquid (A). The liquid (C) was added at 2 mol/min per mole of tetramethoxysilane added as the liquid (B).

The progress of the synthesis reaction was terminated by completing addition of the entire amounts of the liquid (B) and the liquid (C) to obtain a mixed liquid containing silica particles formed. Formation of silica particles in the mixed liquid was confirmed by measuring the average of the longest diameters of silica primary particles, the average secondary particle size of the silica particles, and the concentration of the silica particles in the mixed liquid. The average of the longest diameters of silica primary particles formed was 16 nm. The average secondary particle size of the silica particles formed was 19 nm. The concentration of the silica particles in the mixed liquid was 2.2% by mass.

### (Electrical Conductivity-Increasing Step)

The electrical conductivity of the mixed liquid obtained in the silica particle-forming step (the electrical conductivity of the mixed liquid at the start of the electrical conductivity-increasing step) was measured. After the measurement, the mixed liquid was cooled to 30° C. in 90 minutes while being stirred at 300 rpm to obtain a mixed liquid having an increased electrical conductivity. At the time when the temperature of the mixed liquid had decreased to 30° C., the electrical conductivity of the mixed liquid (the electrical conductivity of the mixed liquid at the end of the electrical conductivity-increasing step) was measured. The electrical conductivity of the mixed liquid at the end of the electrical conductivity-increasing step increased to 134% (=electrical conductivity of mixed liquid at end of electrical conductivity-increasing step/electrical conductivity of mixed liquid at start of electrical conductivity-increasing step×100) as compared to that at the start of cooling.

### (Silica Particle-Growing Step 1)

A liquid (B) obtained by dissolving 88 g of tetramethoxysilane (TMOS manufactured by TAMA CHEMICALS CO., LTD.) in 22 g of methanol and a liquid (C) consisting of 21 g of pure water were continuously added at the same time to the mixed liquid obtained in the electrical conductivity-increasing step with stirring at 300 rpm while the liquid temperature (mixed liquid temperature) in the reaction container was maintained at 30° C. to allow the synthesis reaction to proceed.

The addition rate of the liquid (B) was set to 4.0×10⁻³ mol/min in terms of silicon atoms per mole of water contained in the liquid (A). The liquid (C) was added at 2 mol/min per mole of tetramethoxysilane added as the liquid (B).

The progress of the reaction was terminated by completing addition of the entire amounts of the liquid (B) and the liquid (C) to obtain a mixed liquid containing grown silica particles. The concentration of the silica particles in the mixed liquid was 4.0% by mass.

### (Silica Particle-Growing Step 2)

A liquid (B) obtained by dissolving 379 g of tetramethoxysilane (TMOS manufactured by TAMA CHEMICALS CO., LTD.) in 95 g of methanol and a liquid (C) consisting of 90 g of pure water were continuously added at the same time to the mixed liquid obtained in the silica particle-growing step 1 with stirring at 300 rpm while the liquid temperature (mixed liquid temperature) in the reaction container was maintained at 30° C. to allow the reaction to proceed.

The addition rate of the liquid (B) was set to 5.0×10⁻³ mol/min in terms of silicon atoms per mole of water contained in the liquid (A). The liquid (C) was added at 2 mol/min per mole of tetramethoxysilane added as the liquid (B).

The progress of the reaction was terminated by completing addition of the entire amounts of the liquid (B) and the liquid (C) to obtain a mixed liquid containing grown silica particles. The concentration of the silica particles in the mixed liquid was 9.5% by mass.

### (Water Substitution Step)

The mixed liquid obtained in the silica particle-growing step 2 was heated at a temperature such that a boiling state was reached under ordinary pressure. During the heating, heat distillation was performed while pure water was added in such a manner that the liquid surface was kept at a certain level to displace methanol in the mixed liquid by pure water, thereby obtaining a silica sol.

### Example 3

### (Silica Particle-Forming Step)

A liquid (A) obtained by mixing 1341 g of methanol (manufactured by KANTO CHEMICAL CO., INC.) with 21 g of pure water and 116 g of 29 mass % ammonia water was placed in a 3-liter reaction container having a cooling function and equipped with a stirrer. A liquid (B) obtained by dissolving 88 g of tetramethoxysilane (TMOS manufactured by TAMA CHEMICALS CO., LTD.) in 22 g of methanol and a liquid (C) consisting of 21 g of pure water were continuously added and mixed into the liquid (A) at the same time with stirring at 300 rpm while the liquid temperature (mixed liquid temperature) in the reaction container was maintained at 50° C. to prepare a mixed liquid to allow a synthesis reaction to proceed.

The addition rate of the liquid (B) was 2.0×10⁻³ mol/min in terms of silicon atoms per mole of water contained in the liquid (A). The liquid (C) was added at 2 mol/min per mole of tetramethoxysilane added as the liquid (B).

The progress of the synthesis reaction was terminated by completing addition of the entire amounts of the liquid (B) and the liquid (C) to obtain a mixed liquid containing silica particles formed. Formation of silica particles in the mixed liquid was confirmed by measuring the average of the longest diameters of silica primary particles, the average secondary particle size of the silica particles, and the concentration of the silica particles in the mixed liquid. The average of the longest diameters of silica primary particles formed was 16 nm. The average secondary particle size of the silica particles formed was 19 nm. The concentration of the silica particles in the mixed liquid was 2.2% by mass.

### (Electrical Conductivity-Increasing Step)

The electrical conductivity of the mixed liquid obtained in the silica particle-forming step (the electrical conductivity of the mixed liquid at the start of the electrical conductivity-increasing step) was measured. After the measurement, the mixed liquid was cooled to 30° C. in 90 minutes while being stirred at 300 rpm to obtain a mixed liquid having an increased electrical conductivity. At the time when the temperature of the mixed liquid had decreased to 30° C., the electrical conductivity of the mixed liquid (the electrical conductivity of the mixed liquid at the end of the electrical conductivity-increasing step) was measured. The electrical conductivity of the mixed liquid at the end of the electrical conductivity-increasing step increased to 134% (=electrical conductivity of mixed liquid at end of electrical conductivity-increasing step/electrical conductivity of mixed liquid at start of electrical conductivity-increasing step×100) as compared to that at the start of cooling.

### (Silica Particle-Growing Step 1)

A liquid (B) obtained by dissolving 88 g of tetramethoxysilane (TMOS manufactured by TAMA CHEMICALS CO., LTD.) in 22 g of methanol and a liquid (C) consisting of 21 g of pure water were continuously added at the same time to the mixed liquid obtained in the electrical conductivity-increasing step with stirring at 300 rpm while the liquid temperature (mixed liquid temperature) in the reaction container was maintained at 30° C. to allow the reaction to proceed.

The addition rate of the liquid (B) was set to 2.0×10⁻³ mol/min in terms of silicon atoms per mole of water contained in the liquid (A). The liquid (C) was added at 2 mol/min per mole of tetramethoxysilane added as the liquid (B).

The progress of the reaction was terminated by completing addition of the entire amounts of the liquid (B) and the liquid (C) to obtain a mixed liquid containing grown silica particles. The concentration of the silica particles in the mixed liquid was 4.0% by mass.

### (Silica Particle-Growing Step 2)

A liquid (B) obtained by dissolving 379 g of tetramethoxysilane (TMOS manufactured by TAMA CHEMICALS CO., LTD.) in 95 g of methanol and a liquid (C) consisting of 90 g of pure water were continuously added at the same time to the mixed liquid obtained in the silica particle-growing step 1 with stirring at 300 rpm while the liquid temperature (mixed liquid temperature) in the reaction container was maintained at 30° C. to allow the reaction to proceed.

The addition rate of the liquid (B) was set to 5.0×10⁻³ mol/min in terms of silicon atoms per mole of water contained in the liquid (A). The liquid (C) was added at 2 mol/min per mole of tetramethoxysilane added as the liquid (B).

The progress of the reaction was terminated by completing addition of the entire amounts of the liquid (B) and the liquid (C) to obtain a mixed liquid containing grown silica particles. The concentration of the silica particles in the mixed liquid was 9.5% by mass.

### (Water Substitution Step)

The mixed liquid obtained in the silica particle-growing step 2 was heated at a temperature such that a boiling state was reached under ordinary pressure. During the heating, heat distillation was performed while pure water was added in such a manner that the liquid surface was kept at a certain level to displace methanol in the mixed liquid by pure water, thereby obtaining a silica sol.

### Example 4

### (Silica Particle-Forming Step)

A liquid (A) obtained by mixing 1355 g of methanol (manufactured by KANTO CHEMICAL CO., INC.) with 57 g of pure water and 65 g of 29 mass % ammonia water was placed in a 3-liter reaction container having a cooling function and equipped with a stirrer. A liquid (B) obtained by dissolving 88 g of tetramethoxysilane (TMOS manufactured by TAMA CHEMICALS CO., LTD.) in 22 g of methanol and a liquid (C) consisting of 21 g of pure water were continuously added and mixed into the liquid (A) at the same time with stirring at 300 rpm while the liquid temperature (mixed liquid temperature) in the reaction container was maintained at 30° C. to prepare a mixed liquid to allow a synthesis reaction to proceed.

The addition rate of the liquid (B) was 2.0×10⁻³ mol/min in terms of silicon atoms per mole of water contained in the liquid (A). The liquid (C) was added at 2 mol/min per mole of tetramethoxysilane added as the liquid (B).

The progress of the synthesis reaction was terminated by completing addition of the entire amounts of the liquid (B) and the liquid (C) to obtain a mixed liquid containing silica particles formed. Formation of silica particles in the mixed liquid was confirmed by measuring the average of the longest diameters of silica primary particles, the average secondary particle size of the silica particles, and the concentration of the silica particles in the mixed liquid. The average of the longest diameters of silica primary particles formed was 21 nm. The average secondary particle size of the silica particles formed was 20 nm. The concentration of the silica particles in the mixed liquid was 2.1% by mass.

### (Electrical Conductivity-Increasing Step)

The electrical conductivity of the mixed liquid obtained in the silica particle-forming step (the electrical conductivity of the mixed liquid at the start of addition of ammonia) was measured. After the measurement, a liquid (D) consisting of 49 g of 29 mass % ammonia water was added at once while the mixed liquid was maintained at 30° C. and stirred at 300 rpm, and the resultant was stirred. After adding the liquid (D), the subsequent silica particle-growing step 1 was allowed to proceed at the time when the electrical conductivity of the mixed liquid had increased to 114% as compared to the electrical conductivity of the mixed liquid at the start of addition of ammonia.

### (Silica Particle-Growing Step 1)

A liquid (B) obtained by dissolving 88 g of tetramethoxysilane (TMOS manufactured by TAMA CHEMICALS CO., LTD.) in 22 g of methanol and a liquid (C) consisting of 21 g of pure water were continuously added at the same time to the mixed liquid obtained in the electrical conductivity-increasing step with stirring at 300 rpm while the liquid temperature (mixed liquid temperature) in the reaction container was maintained at 30° C. to allow the synthesis reaction to proceed.

The addition rate of the liquid (B) was set to 2.0×10³ mol/min in terms of silicon atoms per mole of water contained in the liquid (A). The liquid (C) was added at 2 mol/min per mole of tetramethoxysilane added as the liquid (B).

The progress of the reaction was terminated by completing addition of the entire amounts of the liquid (B) and the liquid (C) to obtain a mixed liquid containing grown silica particles. The concentration of the silica particles in the mixed liquid was 3.9% by mass.

### (Silica Particle-Growing Step 2)

A liquid (B) obtained by dissolving 379 g of tetramethoxysilane (TMOS manufactured by TAMA CHEMICALS CO., LTD.) in 95 g of methanol and a liquid (C) consisting of 90 g of pure water were continuously added at the same time to the mixed liquid obtained in the silica particle-growing step 1 with stirring at 300 rpm while the liquid temperature (mixed liquid temperature) in the reaction container was maintained at 30° C. to allow the reaction to proceed.

The addition rate of the liquid (B) was 5.0×10−3 mol/min in terms of silicon atoms per mole of water contained in the liquid (A). The liquid (C) was added at 2 mol/min per mole of tetramethoxysilane added as the liquid (B).

The progress of the reaction was terminated by completing addition of the entire amounts of the liquid (B) and the liquid (C) to obtain a mixed liquid containing grown silica particles. The concentration of the silica particles in the mixed liquid was 9.3% by mass.

### (Water Substitution Step)

The mixed liquid obtained in the silica particle-growing step 2 was heated at a temperature such that a boiling state was reached under ordinary pressure. During the heating, heat distillation was performed while pure water was added in such a manner that the liquid surface was kept at a certain level to displace methanol in the mixed liquid by pure water, thereby obtaining a silica sol.

### Comparative Example 1

A liquid (A) obtained by mixing 2945 g of methanol with 375.92 g of pure water, 108 g of 29 mass % ammonia water, and 91 g of colloidal silica (silica concentration: 12% by mass, average secondary particle size: 25 nm) was placed in a 5-liter reaction container having a cooling function and equipped with a stirrer, and a liquid (B) obtained by dissolving 309 g of tetramethoxysilane (TMOS) in 79 g of methanol was added at 11 mL/min to the liquid (A) with stirring at 300 rpm while the liquid temperature in the reaction container was maintained at 20° C. to prepare a reaction liquid, thereby obtaining a silica sol.

### Comparative Example 2

A silica sol was obtained in the same manner as in Comparative Example 1 except that the addition rate of the liquid (B) was changed from 11 mL/min to 5.5 mL/min.

The amounts of the raw materials and the conditions used in the methods for producing a silica sol according to Examples 1 to 4 and Comparative Examples 1 and 2 are summarized in Tables 1 to 4. The concentration of silica particles, the average primary particle size of silica particles, the average aspect ratio, the proportion of the number of silica particles having an aspect ratio of 1.50 or more to the total number of silica particles, the average degree of circularity, and the proportion of the number of silica particles having a degree of circularity of 0.90 or more to the total number of silica particles determined for the silica sols according to Examples 1 to 4 and Comparative Examples 1 and 2 are shown in Table 5.

TABLE 1

| | Silica particle-forming step | | | | | | | | | | | | |
|---|---|---|---|---|---|---|---|---|---|---|---|---|---|
| | | | | | | | | | | | | | Average |
| | | | | | | | | Addition | Addition | | Silica | | secondary |
| | Liquid (A)[g] | | | | | | Liquid | rate of | rate of | | particle | | particle |
| | | | | Silica | Liquid (B)[g] | | (C)[g] | liquid | liquid | Temper- | concen- | Silica | size of |
| | Metha- | | Pure | parti- | | Metha- | Pure | (B)*1 | (C)*2 | ature | tration*3 | particle | silica |
| | nol | Ammonia | water | cle | TMOS | nol | water | [mol/min] | [mol/min] | [° C.] | [mass %] | length*4 | particles*5 |
| Example | 1296 | 34 | 148 | 0 | 88 | 22 | 21 | 1.4 × 10⁻³ | 2.0 | 50 | 2.2 | 21 | 22 |
| 1 | | | | | | | | | | | | | |
| Example | 1341 | 34 | 103 | 0 | 88 | 22 | 21 | 2.0 × 10⁻³ | 2.0 | 50 | 2.2 | 16 | 19 |
| 2 | | | | | | | | | | | | | |
| Example | 1341 | 34 | 103 | 0 | 88 | 22 | 21 | 2.0 × 10⁻³ | 2.0 | 50 | 2.2 | 16 | 19 |
| 3 | | | | | | | | | | | | | |
| Example | 1355 | 19 | 103 | 0 | 88 | 22 | 21 | 2.0 × 10⁻³ | 2.0 | 30 | 2.1 | 21 | 20 |
| 4 | | | | | | | | | | | | | |
| Comparative | 2945 | 31 | 533 | 11 | 309 | 79 | — | 1.9 × 10⁻³ | — | 20 | — | — | — |
| Example | | | | | | | | | | | | | |
| 1 | | | | | | | | | | | | | |
| Comparative | 2945 | 31 | 533 | 11 | 309 | 79 | — | 9.4 × 10⁻⁴ | — | 20 | — | — | — |
| Example | | | | | | | | | | | | | |
| 2 | | | | | | | | | | | | | |

*1Addition rate of liquid (B) (in terms of silicon atoms) per mole of water contained in liquid (A)
*2Addition rate of liquid (C) per mole of tetramethoxysilane (in terms of silicon atoms) added as liquid (B)
*3Concentration of silica particles in mixed liquid at end of silica particle-forming step
*4Average of longest diameters of silica primary particles in mixed liquid at end of silica particle-forming step
*5Average secondary particle size of silica particles in mixed liquid at end of silica particle-forming step

TABLE 2

| | Electrical conductivity-increasing step | | | |
|---|---|---|---|---|
| | | Temperature | Temperature | |
| | | of mixed | of mixed | Electircal |
| | | liquid at | liquid at | conductivity |
| | Ammonia*1 | start of step | end of step | increase rate |
| | [g] | [° C.] | [° C.] | [%] |
| Example 1 | — | 50 | 30 | 128 |
| Example 2 | — | 50 | 30 | 134 |
| Example 3 | — | 50 | 30 | 134 |
| Example 4 | 49 | 30 | 30 | 114 |
| Comparative | Not performed | | | |
| Example 1 | | | | |
| Comparative | Not performed | | | |
| Example 2 | | | | |

*1Amount of 29 mass % ammonia water

TABLE 3

| | Silica particle-growing step 1 | | | | | | |
|---|---|---|---|---|---|---|---|
| | | | Liquid | Addition | Addition | | Mixed |
| | | | (C)[g] | rate of | rate of | Silica particle | liquid |
| | Liquid (B)[g] | | Pure | liquid (B)*1 | liquid (C)*2 | concentration*3 | temperature |
| | TMOS | Methanol | water | [mol/min] | [mol/min] | [mass %] | [° C.] |
| Example 1 | 88 | 22 | 21 | 2.8 × 10⁻³ | 2.0 | 4.0 | 30 |
| Example 2 | 88 | 22 | 21 | 4.0 × 10⁻³ | 2.0 | 4.0 | 30 |
| Example 3 | 88 | 22 | 21 | 2.0 × 10⁻³ | 2.0 | 4.0 | 30 |
| Example 4 | 88 | 22 | 21 | 2.0 × 10⁻³ | 2.0 | 3.9 | 30 |
| Comparative | Not performed | | | | | | |
| Example 1 | | | | | | | |
| Comparative | Not performed | | | | | | |
| Example 2 | | | | | | | |

*1Addition rate of liquid (B) (in terms of silicon atoms) per mole of water contained in liquid (A)
*2Addition rate of liquid (C) per mole of tetramethoxysilane (in terms of silicon atoms) added as liquid (B)
*3Concentration of silica particles in mixed liquid at end of silica particle-growing step 1

TABLE 4

| | Silica particle-growing step 2 | | | | | | |
|---|---|---|---|---|---|---|---|
| | | | Liquid | Addition | Addition | | Mixed |
| | | | (C)[g] | rate of | rate of | Silica particle | liquid |
| | Liquid (B)[g] | | Pure | liquid (B)*1 | liquid (C)*2 | concentration*3 | temperature |
| | TMOS | Methanol | water | [mol/min] | [mol/min] | [mass %] | [° C.] |
| Example 1 | 379 | 95 | 90 | 3.5 × 10⁻³ | 2.0 | 9.5 | 30 |
| Example 2 | 379 | 95 | 90 | 5.0 × 10⁻³ | 2.0 | 9.5 | 30 |
| Example 3 | 379 | 95 | 90 | 5.0 × 10⁻³ | 2.0 | 9.5 | 30 |
| Example 4 | 379 | 95 | 90 | 5.0 × 10⁻³ | 2.0 | 9.3 | 30 |
| Comparative | Not performed | | | | | | |
| Example 1 | | | | | | | |
| Comparative | Not performed | | | | | | |
| Example 2 | | | | | | | |

*1Addition rate of liquid (B) (in terms of silicon atoms) per mole of water contained in liquid (A)
*2Addition rate of liquid (C) per mole of tetramethoxysilane (in terms of silicon atoms) added as liquid (B)
*3Concentration of silica particles in mixed liquid at end of silica particle-growing step 2

TABLE 5

| | Silica particles in silica sol | | | | | | | |
|---|---|---|---|---|---|---|---|---|
| | | | | | | | Degree of circularity | |
| | | Average | Average | | Aspect ratio | | | Ratio of silica |
| | | primary | secondary | | | Ratio of silica | | particles having |
| | | particle | particle | Average | | particles having | | degree of |
| | Concentration | size | size | degree of | | aspect ratio of 1.50 | | circularity of 0.90 |
| | [mass %] | [nm] | [nm] | association | Average | or more [%]*1 | Average | or more [%]*2 |
| Example | 9.5 | 37 | 72 | 1.9 | 1.54 | 52 | 0.71 | 21 |
| 1 | | | | | | | | |
| Example | 9.5 | 27 | 88 | 3.3 | 1.60 | 54 | 0.59 | 13 |
| 2 | | | | | | | | |
| Example | 9.5 | 24 | 57 | 2.4 | 1.55 | 50 | 0.74 | 28 |
| 3 | | | | | | | | |
| Example | 9.3 | 25 | 67 | 2.7 | 1.60 | 53 | 0.60 | 11 |
| 4 | | | | | | | | |
| Comparative | 3.4 | 34 | 103 | 3.0 | 1.30 | 18 | 0.87 | 54 |
| Example | | | | | | | | |
| 1 | | | | | | | | |
| Comparative | 3.4 | 34 | 65 | 1.9 | 1.29 | 20 | 0.85 | 57 |
| Example | | | | | | | | |
| 2 | | | | | | | | |

*1Ratio of number of silica particles having aspect ratio of 1.50 or more to number of all silica particles
*2Ratio of number of silica particles having degree of circularity of 0.90 or more to number of all silica particles

As can be seen from Table 5, the silica particles in the silica sols of Examples 1 to 4 have a higher average aspect ratio of 1.50 or more as compared to the silica particles in the silica sols of Comparative Examples 1 and 2, and the proportions of the number of silica particles having an aspect ratio of 1.50 or more to the total number of silica particles of the silica sols of Examples 1 to 4 are 40% or more, which confirms that the silica sols of Examples 1 to 4 contain many silica particles having a high aspect ratio.

As can be seen from Table 5, the silica particles in the silica sols of Examples 1 to 4 have a lower average degree of circularity of 0.80 or less as compared to the silica particles in the silica sols of Comparative Examples 1 and 2, and the ratios of the number of silica particles having a degree of circularity of 0.90 or more, as calculated on the basis of the image obtained by observation with a scanning electron microscope, of the silica sols of Examples 1 to 4 are 40% or less, which confirms that the silica sols of Examples 1 to 4 contain many deformed silica particles.

As can be seen from Table 5, the silica sols of Examples 1 to 4 have a higher silica particle concentration as compared to the silica sols of Comparative Examples 1 and 2.

This application is based on Japanese Patent Application No. 2025-045714 filed on Mar. 19, 2025, the disclosure of which is incorporated herein by reference in its entirety.

1. A method for producing a silica sol, comprising:
mixing continuously or intermittently a liquid (A) containing an alkaline catalyst, water, and a first organic solvent with a liquid (B) containing at least one of tetramethoxysilane or a condensate thereof, and a second organic solvent, wherein
the mixing includes, after formation of silica particles in a mixed liquid, increasing a value of electrical conductivity of the mixed liquid.

2. The production method according to claim 1, wherein the increasing the value of electrical conductivity of the mixed liquid is achieved by increasing an amount of ions derived from the alkaline catalyst in the mixed liquid.

3. The production method according to claim 1, wherein the increasing the value of electrical conductivity of the mixed liquid is achieved by decreasing a temperature of the mixed liquid.

4. The production method according to claim 1, wherein the increasing the value of electrical conductivity of the mixed liquid is achieved by adding a liquid (D) containing ammonia to the mixed liquid.

5. The production method according to claim 1, wherein the mixing further includes mixing at least one selected from the liquid (A) and the mixed liquid with a liquid (C) containing water.

6. The production method according to claim 1, wherein an increase rate of the value of electrical conductivity of the mixed liquid is 110% or more.

7. The production method according to claim 1, wherein the value of electrical conductivity of the mixed liquid is increased when the silica particles have an average secondary particle size of 5 nm or more and 300 nm or less.

8. A silica sol comprising silica particles having an average aspect ratio of 1.50 or more, wherein
a proportion of the number of silica particles having an aspect ratio of 1.50 or more to the total number of silica particles is 40% or more, and
a concentration of the silica particles is 4% by mass or more.

9. The silica sol according to claim 8, wherein a proportion of the number of silica particles having a degree of circularity of 0.90 or more to the total number of silica particles is 40% or less.
